(19) United States
(12) Patent Application Publication
(10) Pub. No.: US 2010/0037540 A1
(43) Pub. Date: Feb. 18, 2010

(54) APPLICATOR FOR DISPENSING A ROLLED CONSTRUCTION MATERIAL

(76) Inventor: Dennis P. Atkins, Independence, MO (US)

Correspondence Address: POLSINELLI SHUGHART PC, 700 W. 47TH STREET, SUITE 1000, KANSAS CITY, MO, 64112-1802, US

(21) Appl. No.: 12/190,099

(22) Filed: Aug. 12, 2008

(51) Int. Cl. E04D 13/00; B65H 77/00; E04B 1/00; A47F 13/00; B26D 7/02

(52) U.S. Cl. 52/173.1; 242/410; 52/741.1; 248/309.1; 83/455

(57) ABSTRACT

Systems and methods for installing a rolled construction material to a building are described. The systems and methods may be used to install a variety of rolled construction materials on roof structures and surfaces and on building wall structures and surfaces. The system includes an applicator that suspends from a trolley. The applicator includes a shaft and a motor operatively engaged to the shaft for unwinding a roll of the rolled construction material on the shaft. The trolley is in a moveable engagement with a trolley housing. A support connected to the building positions the trolley housing adjacent the building.

### FIELD OF THE INVENTION

The present invention relates to an applicator for dispensing a rolled construction material and methods of installing a rolled construction material. The rolled construction material includes a fall protection safety barrier that is installed between the purlins of a roof.

### BACKGROUND OF THE INVENTION

U.S. Pat. No. 6,094,883, which is hereby incorporated by reference, describes a roof covering, including a thin film safety barrier coupled between the lower flanges of spaced roof purlins for supporting the weight of a person thereon in the space between the purlins. However, this patent fails to adequately address the safety concerns of installing the roof covering. Roof coverings are typically available in heavy rolls of material. The rolls are cumbersome for workers manually handling the rolls. The rolls of material are unwound at elevated locations and the material is stretched across the underneath surfaces of the purlins, where the material is attached to the purlins using straps. It is difficult to hold the material against the purlins during installation. Sags and wrinkles may distract from the performance and aesthetic value of the material. Many workers are required to manually install the material. Moreover, the workers are working at elevated positions, while trying to manually unwind the roll of material and install it flush against the underneath surface of the purlins. A safer and more efficient method of installing rolled construction materials is needed.

### SUMMARY OF INVENTION

Systems and methods for installing a rolled construction material to a building are described. The systems and methods may be used to install a variety of rolled construction materials on roof structures and surfaces and on building wall structures and surfaces.

The system includes an applicator that suspends from a trolley. The applicator includes a shaft and a motor operatively engaged to the shaft for unwinding and rewinding a roll of the rolled construction material on the shaft. The trolley is in a moveable engagement with a trolley housing. A support connected to the building positions the trolley housing adjacent to the building.

Another embodiment of the applicator includes a spring tension guide roller assembly mounted to an applicator platform. The spring tension guide roller includes one or more pinch rollers that receive the material unwound from the roll. An adjustable torsion brace supports the spring tension guide roller assembly. The height of the spring tension guide roller assembly is adjustable relative to the applicator platform in order to position and dispense the material from the applicator at a height similar to the lower edge of purlins of a building.

Another embodiment includes an electric drive motor having a drive shaft operatively engaged to a drive roller for rotating the drive roller along the trolley housing. An applicator platform is mounted to the electric drive motor, wherein the electric drive motor moves the applicator platform in a side to side manner on the trolley housing. An applicator platform includes the applicator to unwind the roll of the rolled construction material.

Another embodiment includes a rolled material attachment tool. The rolled material attachment tool is utilized to cut a straight leading edge of the material, clamp, and hold the material, and then temporarily attach the material to the vertical surface of the purlin. The tool includes a central portion defining an entry opening, a passage, and a slot. The entry opening is in open communication with the passage and the slot. The slot extends across the central portion. The slot is generally perpendicular to the entry opening. The slot provides access to the material in the slot for trimming an edge of the material in a square manner. Clamps are integral or attached to central portion. The clamps hold the material in the passage.

Another embodiment includes a rolled material installation support system. The rolled material installation support system is used to support the material during the installation of the material on roofing structures, such as the purlins. The support system includes first and second rolled material installation supports. The first rolled material installation support includes a first attachment assembly to temporarily attach to a rafter. A first vertical member is adjustably connected to the first attachment assembly. A strap is connected to the first vertical member. The strap is configured to connect to the second rolled material installation support or directly to a bay or rafter. The second rolled material installation support includes a second attachment assembly to also temporarily attach to a rafter and a second vertical member adjustably connected to the second attachment assembly. A roller may be incorporated at the top of the second vertical member of the second rolled material installation support to make it easier to tighten the strap coming from the first vertical member or from a strap attached across the bay or rafter. The strap extends from the first vertical member to the second vertical member, or from one side of the bay, or rafter, to the opposite side of the bay and corresponding rafter.

### BRIEF DESCRIPTION OF THE DRAWINGS

FIG. 1 is a side view of the applicator suspended from a roof.

FIG. 2 is a side view of the applicator and the applicator platform.

FIG. 3 is a plan view of the applicator.

FIG. 4 is a front view of the applicator.

FIG. 5 is a view of the rolled material installation support system.

FIG. 6 is a side sectional view of the embodiment with motor driven side to side movement.

FIG. 7 is front sectional view of the embodiment with motor driven side to side movement.

FIG. 8(A) a top view of the rolled material attachment tool.

FIG. 8(B) a side sectional view of the rolled material attachment tool.

FIGS. 9(A)-(C) are views of the safety chuck.

FIGS. 10(A)-(C) are views of the core chuck.

FIG. 11 is a view of the rolled construction material dispensed and installed to the building surface.

### DETAILED DESCRIPTION OF PREFERRED EMBODIMENTS

An applicator for dispensing a rolled construction material and methods of installing a rolled construction material are described. The rolled construction material may be used to form a fall protection safety barrier that is installed between purlins of a roof.

The applicator provides for the safe dispensing and application of the rolled construction material, such as a thin film safety barrier, that is coupled between the flanges of spaced roof purlins for supporting the weight of a person thereon in the space between the purlins in case of an accidental fall. The applicator promotes the safe dispensing and application of heavy rolls of the rolled construction material and overcomes many of the hazards of prior methods of installing rolled construction materials.

The applicator may be used to dispense a variety of rolled construction materials, including the thin film safety barrier, vapor barriers, decorative coverings, and other rolled materials used in the residential and commercial construction industry. The rolled construction material may be applied to purlins, rafters, and other roof structural members such as beams and bar joists, as well over other support structures and surfaces on the interior or exterior of the building, such as studs, girds, etc. As such, the applicator may also be used to cover both horizontally and vertically oriented surfaces and structures on the building.

The applicator uses side to side movement to improve the safety and efficiency of the installation of the rolled construction material. The applicator is suspended from a trolley in a moveable engagement with a trolley housing. The movable engagement between the trolley and the trolley housing provides for side to side adjustment of the lateral position of the applicator for parallel alignment with rafters and walls. This aids in the reduction of wrinkles and allows the material to be applied flat against the purlins, joists, delta joists and other roofing support members.

The side to side movement of the applicator may be controlled manually or via various mechanical means such as a link chain, cable, gears, motors or other pressure application roller devices. For example, an adjustable height, remote controlled reversible electric motor that turns a pulley and propels itself along a fixed cable may be utilized for the side to side movement. Also, pressure rollers turned by an electric motor against the trolley housing may be utilized for the side to side movement. The electric motors used are suitable for an outdoor, wash down, environment.

The system comprises one or more rewind mechanisms to pull the unrolled construction material tight against the purlins or other building surface as it is attached. Often extra construction material is pulled from the applicator, and the rewind mechanism, such as the reversing of a motor in the applicator, eliminates the sagging of the unrolled construction material and aids in aesthetic value.

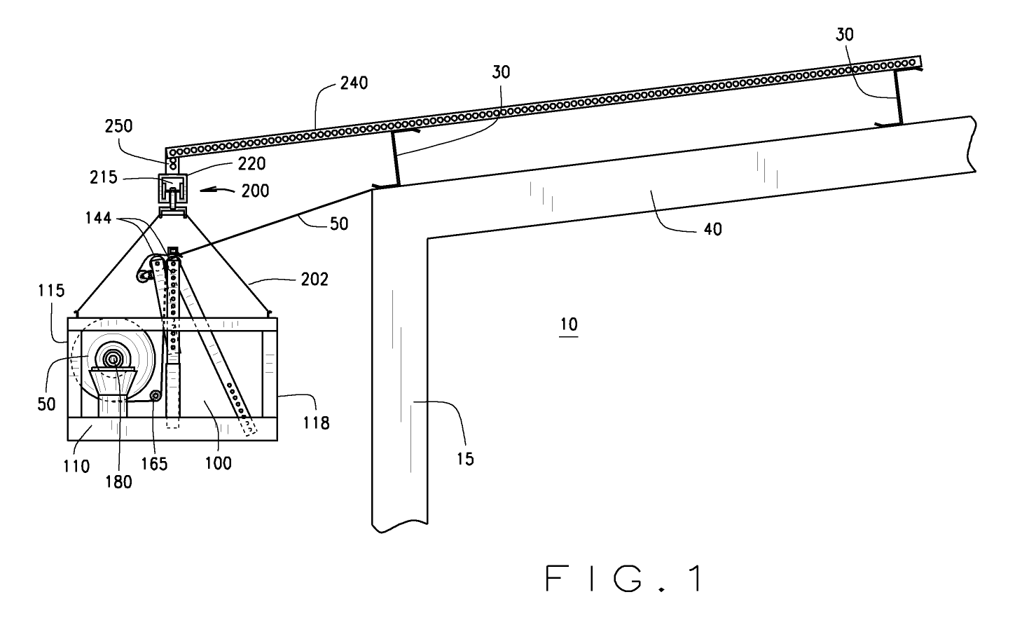

FIG. 1 shows a view of an applicator 100. The applicator 100 is suspended on a moving trolley 200 in movable engagement with a trolley housing 220 up to the entire area of the inside or outside of a building 10 where a rolled construction material 50, such as a safety barrier for roof construction, is being installed. The applicator 100 may be placed on the inside or outside of a building wall 15. The applicator 100 may also be placed on the ground on the inside or outside of the building 10. The applicator 100 may be placed on the ground inside the building 10 to cover an interior end wall as there are no available purlins for suspending the applicator 100.

The trolley housing 220 includes a round, box, square, a suspended or hanging bar track, guide rail or other devices that supports the trolley 200 in a movable engagement. The trolley housing 220 may define a track 210 and a travel channel 215, which may be positioned internal or external to the trolley housing 200. The trolley 200 may include a round pulley or series of pulleys that allow side to side or end to end movement of the applicator 100 along the building 10 where the rolled construction material 50 is being installed. The trolley 200 may rotatably engage the track 210 and move within the travel channel 215, which are positioned internal to the trolley housing 220. The trolley 200 may also rotatably engage the track 210 and move about the travel channel 215, which are positioned on an exterior surface of the trolley housing 220. Suspending or mounting the applicator 100 on the trolley 200 provides side to side adjustment capability for the applicator 100. The side to side adjustment capability of the applicator 100 and the unwind/rewind of the material 50 may be controlled via remote electronic wireless control, hardwired control, or various other physical means.

The applicator 100 is positioned on an applicator platform 110. The applicator platform 110 may be suspended from the trolley 200 by ratcheted tie down straps 200 or a cable placed through a pulley attached to the trolley 200. The ratcheted tie down straps 202 aid in height adjustment of the applicator 100.

Suspending the applicator 100 with the rolled construction material 50 at the front of the applicator platform 110 aids in the ease of replacement when the roll of the rolled construction material 50 is spent, since the worker may access the applicator platform from a front side 115 of the applicator platform 110 that is opposite of the building 10, where an implement such as crane, ladder truck, snorkel-lift or the like may be utilized to lift the worker into a safe position to replace the spent roll with a new roll of the rolled construction material 50. However, the applicator 100 may easily be placed in a rear position, i.e., at a rear side 118 of the platform 110 by reversing the applicator 100. The platform 110 provides a protective work area or space for various components of the applicator 100, including, for example, electronic controls 425, a double face tape applicator 187, the rolled construction material 50, a roller motor 170 for application of the material 50, and an electric drive motor 300 for side to side movement of the applicator platform 110.

The side to side adjustment capability of the applicator 100, by virtue of its attachment to the trolley 200, is useful for alignment of the rolled construction material 50 with the purlins 30, rafters 40, and/or other structures of the building 10. The side to side adjustment capability of the applicator 100 aids in the prevention of wrinkling of the construction material 50 during the installation of the construction material 50.

The trolley housing 220 is supported by attaching support mechanisms to the top, sides or lower area of the roof purlins 30. The support mechanisms may include square, perforated or solid box tubing such as TELESPAR or TELESTRUT material, angle iron, c channel or other similar material of suitable strength. As shown in FIG. 1, a lateral trolley support 240 is connected to a top surface of the purlins 30. A vertical trolley support 250 is connected to the lateral trolley support 240. The vertical trolley support 250 is connected to the trolley housing 220. The combination of the lateral trolley support 240 and the vertical trolley support 250 form a supporting structure with a cantilever design to suspend the trolley housing 220.

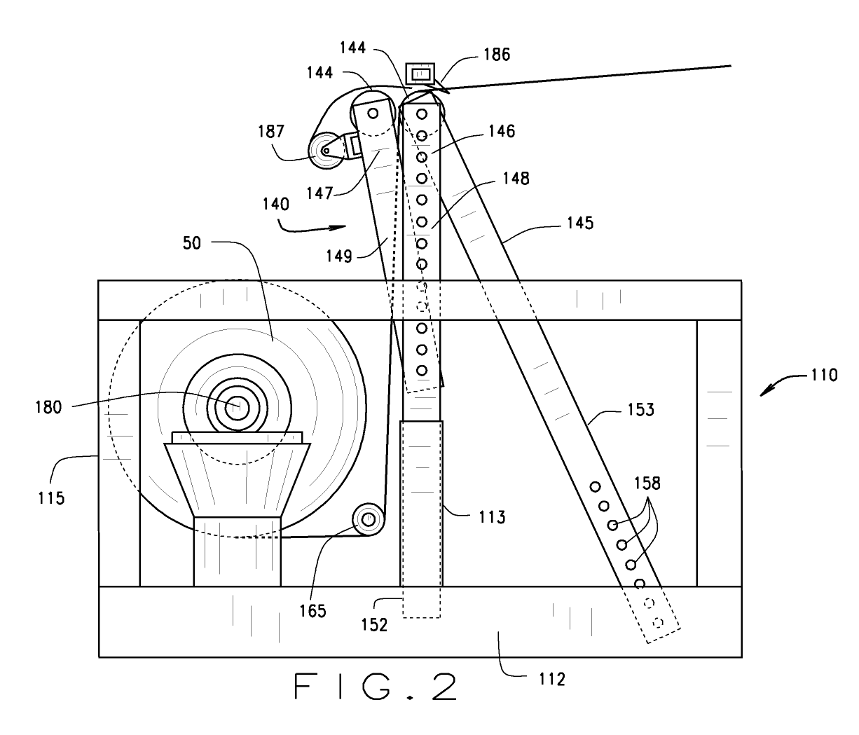

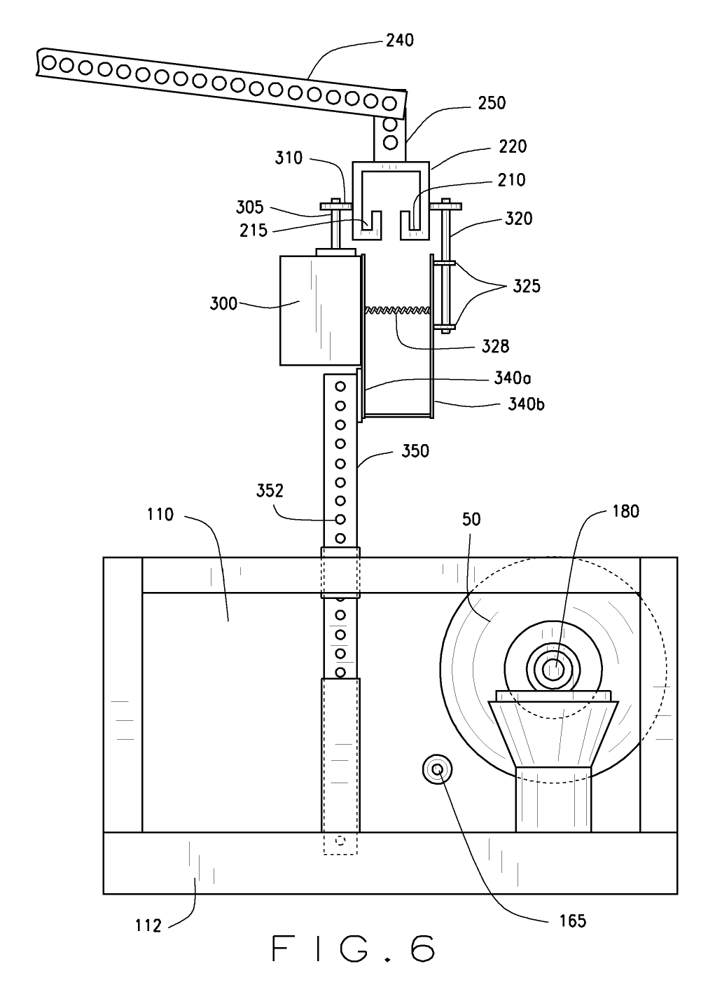

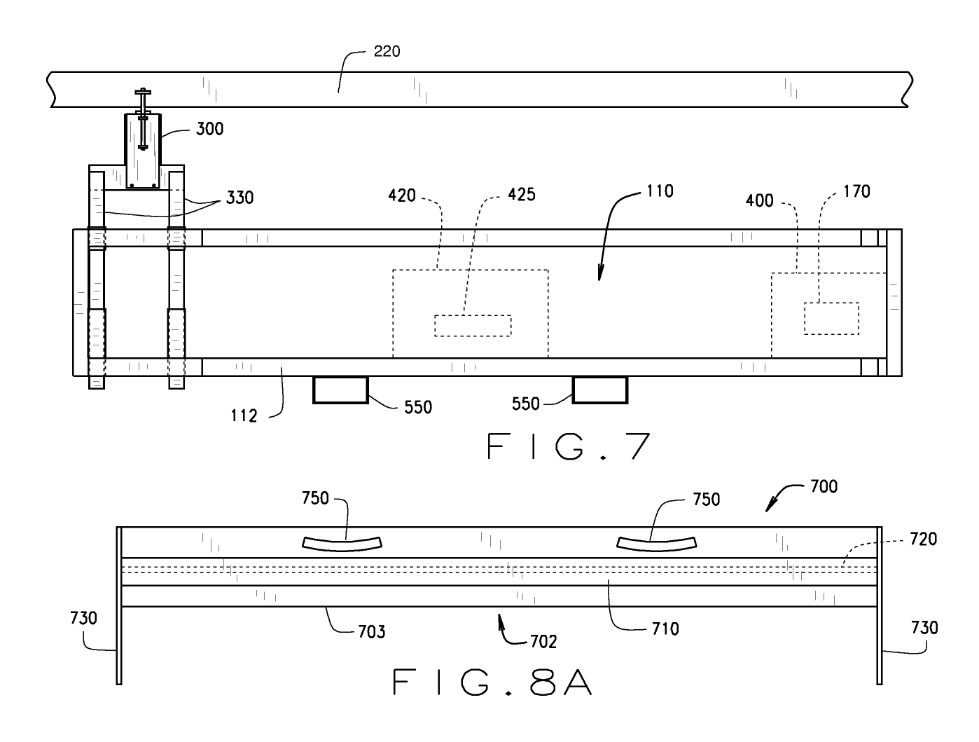

FIG. 2 shows a side view of the applicator platform 110, which includes the applicator 100, a spring tension guide roller assembly 140, an adjustable torsion brace 145, and an idler roller 165. The applicator 100 comprises a roller motor 170 that is operatively engaged to a shaft 180. The rolled construction material 50 is positioned on the shaft 180. The roller motor 170 turns the shaft 180 for the unwinding and rewinding of the rolled construction material 50. One or more forklift points 550, shown in FIGS. 4 and 7, are provided on the underneath surface of the applicator platform 110 which assist in lifting the applicator platform 110 to the trolley 200.

The spring tension guide roller assembly 140 comprises one or more pinch rollers 144 to aid in the positioning and dispensing of the material 50 and a torsion brace 145 to support the spring tension guide roller assembly 140. The pinch rollers 144 are mounted on an extending end 146 of a torsion brace vertical member 148 and on an extending end 147 of pinch roller support member 149. A base end 152 of the torsion brace vertical member 148 is connected to a base 112 of the applicator platform 110. The torsion brace vertical member 148 may be vertically adjustable with respect to the base 112 of the applicator platform 110 by moving a receiving member 113 of the base 112.

A torsion brace support member 153 is movably attached to the base 112 of the applicator platform 110. The torsion brace support member 153 comprises a plurality of holes 158 that receive a pin in a removable locking engagement. The pin also passes through the base 112 of the applicator platform 110 in a removable locking engagement. By selecting different holes 158 of the torsion brace support member 153 in order to attach the base 112, the pinch rollers 144 are provided with firm support.

The spring tension guide roller assembly 140 is adjustable relative to the applicator platform 110 in order to position and dispense the material 50 from the applicator 100. The pinch rollers 144 provide a degree of tension to the material 50 in order to help remove wrinkles and sags as the material 50 is dispensed along the building surface. Typically, the spring tension guide roller assembly 140 raises the material 50 above the applicator platform 110 and closer to its intended position during the dispensing of the material 50 for a roofing application. The spring tension guide roller assembly 140 also directs the material 50 from applicator platform 110 in order to reduce the likelihood of the material 50 snagging or catching on the applicator platform 110.

When installing the material 50 to form a safety barrier underneath the purlins 30, the spring tension guide roller assembly 140 provides an adjustable means of dispensing the safety barrier at a height similar to the lower edge of the purlins 30. A slitter blade 186, such as a carpet knife or the like, for trimming the material 50 to specific widths for the building 10 may also be attached to the spring tension guide roller assembly 140. A support, such as angle iron, may be attached to the torsion brace vertical member 148 in parallel to the pinch roller 144. The slitter blade 186 may clamp or attach to the support, thereby moveable to the desired width, to trim the material 50. The double face tape applicator 187 may be attached or mounted to the support.

The spring tension guide roller assembly 140 also provides a means to capture the material 50 to prevent it from falling around the roll of construction material 50 being dispensed after securing and trimming the material 50 at the last purlin covered. The double face tape applicator 187 and a pressure roller may also be incorporated into the spring tension guide roller assembly 140 to apply tape as the material 50 is unwound from the rolled construction material 50.

The spring tension guide roller assembly 140 may be also motor driven with an electric clutch control for the unwind/remind operation. The unwind/rewind of the rolled construction material 50 may also be motor driven via an electric clutch control attached to the roller motor 170 or the shaft 180. Such an operation requires the use of only one reversible motor.

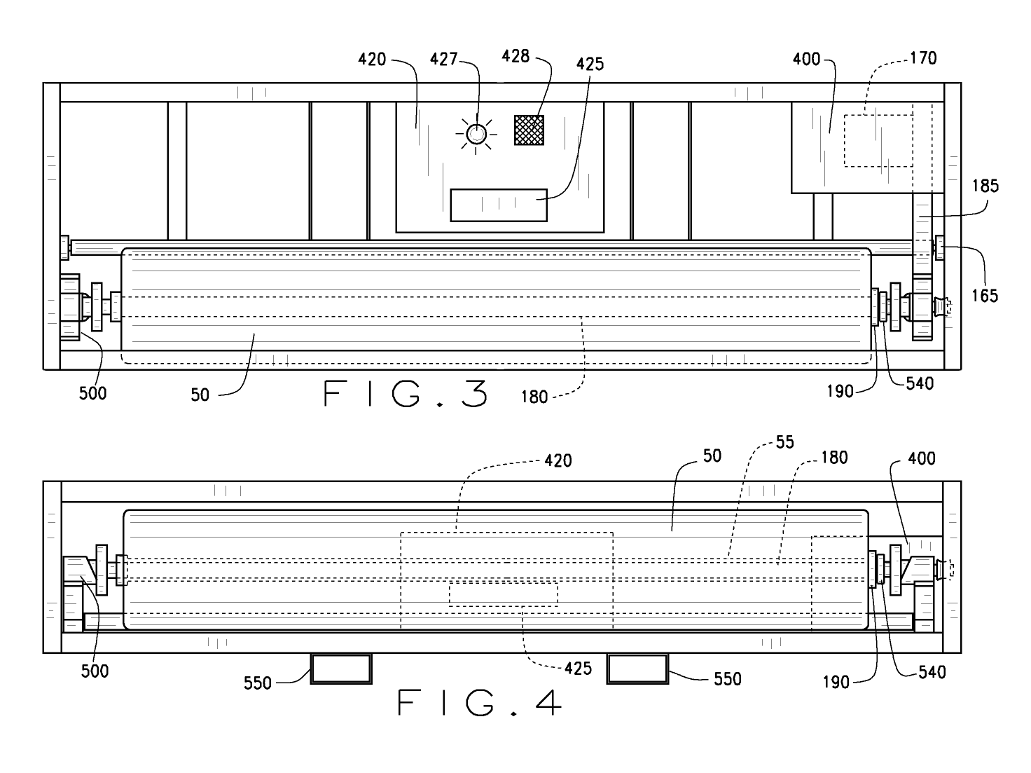

Turning now to FIGS. 3 and 4, a plan and front view of the applicator platform 110 are shown. A roller motor enclosure 400 houses the roller motor 170. A control enclosure 420 houses the electronic controls 425, which may include receivers, controllers, processors, etc. to control and operate the applicator 100.

The electronic controls 425 will now be described. A tamperproof hour meter may be incorporated in the electronic controls 425 to monitor and indicate hours of use of the applicator 100. A linear footage counter may be used to control the number of feet of material unwound from the rolled construction material 50, thus eliminating potential time lost in rewinding. An optional rotating warning light 427 and/or an audible warning device 428 may be incorporated into the applicator 100 to reminded workers of the side to side movement of the applicator 100 and of the unwind and rewind operations of the rolled construction material 50. The applicator 100 may include sensors to monitor the diameter of the rolled construction material 50, thus calculating remaining supply and linear footage used, electrical and/or hydraulic system functions, remaining double face tape supply, and when quantities would need to be replenished. All controls of the applicator 100 would have the capability to be changed from an automatic to a manual control status.

Where a reliable power supply may be available, the electronic controls 425 for the applicator 100 may be enhanced via computerized wireless remote or hardwired controls and/or operated via electrical and or hydraulic methods. Input and output monitor and control signals may be hardwired or wireless. Laser and or optical alignment of the rolled construction material 50 as it is applied may be utilized to aid in a wrinkle free installation. Controlling the process via a remote control system, receiving and sending signals from laser and or optical sensors to control mechanisms will ease labor, speed installation and upgrade quality control.

The operation of the roller motor 170 will now be described. The roller motor 170 is operatively engaged to the shaft 180 via a belt 185. In other embodiments, a direct drive engagement where the roller motor 170 is directly connected to the shaft 180 may be utilized. A suitable roller motor 170 is an outdoor, wash down environment motor commercially available from an electric motor supply house. The roller motor 170 may be a gear reduction motor and/or include variable speed control.

An optional brake assembly 190, electric or manually operated, may be mounted on the shaft 180 or may be configured internally within the roller motor 170 for performing the unwind and rewind operation. The brake assembly 190 provides a means to apply backpressure to retard freewheeling of the rolled construction material 50 as it is applied or rewound. The brake assembly 190 may include a disk brake, utilized to add drag to the shaft 180 holding the rolled construction material 50 so that it does not freewheel during dispensing operations. The brake assembly 190, may be controlled via manual, electrical, computerized or hydraulic methods. Control input may come from the electronic controls 425, laser and/or optical sensors.

A safety chuck 500 and a core chuck 540 secure the rolled construction material 50 to the shaft 180. The rolled construction material 50 includes a paper core 55, which is typically hollow. The safety chuck 500 and core chuck 540 provide for the safe and efficient replacement of a spent roll of construction material 50. The safety chuck 500 includes a square slot 505 to receive an end of the shaft 180.

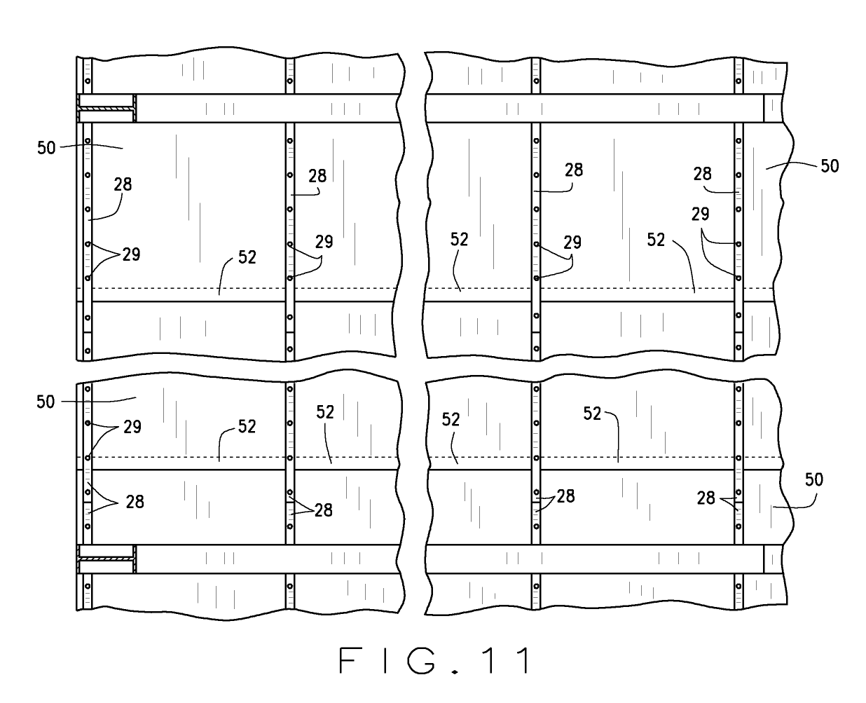

With reference to FIG. 11, as or after the material 50 is placed onto the building surfaces, support or attachment means, such as plastic or metal straps 28, plastic or metal strips, staples, adhesives, tacks, nails, metal fasteners, etc. are used to permanently attach the material to the building surface. The plastic or metal straps 28 are often used when the material 50 is installed as a fall protection barrier. The plastic or metal straps 28 may be used with fasteners 29, such as self-tapping metal screws.

Support webbing, spanning the distance between the rafters and parallel to the purlins, may also be utilized to support the weight of the rolled construction material 50 so as it unrolls from the applicator 100 and prior to the attachment to the lower edge of the purlins 30.

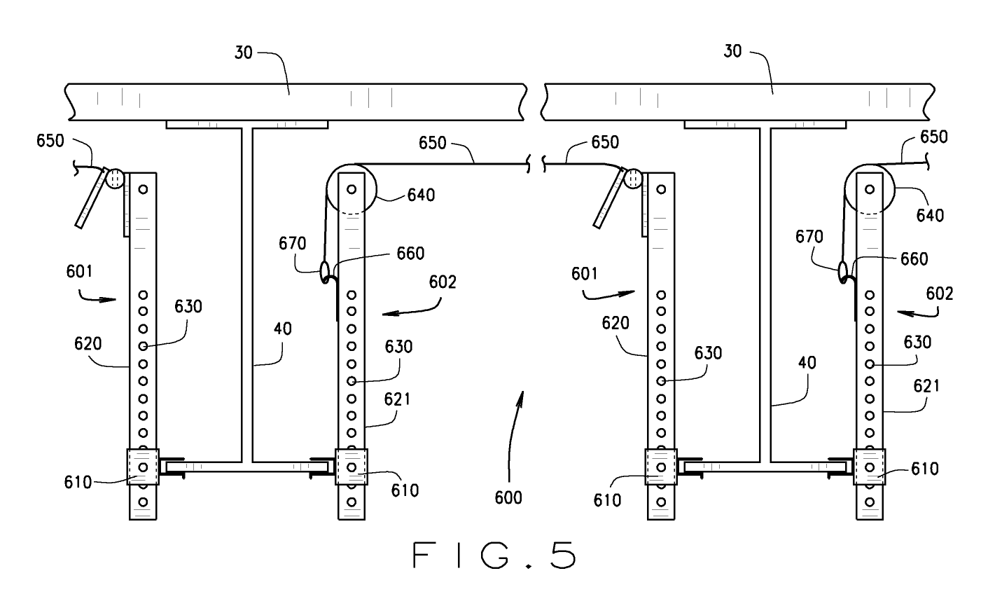

Turning now to FIG. 5, a rolled material installation support system 600 is shown. The rolled material installation support system 600 may be used in conjunction with or to replace the support webbing. The rolled material installation support system 600 is used to support the material 50 during the installation of the material 50 on roofing structures, such as the purlin 30. The rolled material installation support system 600 is especially useful when installing a safety barrier under the purlins 30. As the material 50 is dispensed from the applicator 100, the rolled material installation support system 600 supports the material 50 and prevents it from falling down. After the material 50 is attached to the purlin 30 as described above, the rolled material installation support system 600 is removed from the rafter 40.

The rolled material installation support system 600 temporarily attached to the rafters 40. Generally, the rolled material installation support system 600 is temporarily attached between the purlins 30. The rolled material installation support 600 system includes a first rolled material installation support 601 and a second rolled material installation support 602. Each rolled material installation support 601 and 602 includes attachment assemblies 610, such as a clamp, bracket, receiver, etc. that removably attaches to a bottom edge or surface of the rafter 40.

The rolled material installation support 601 includes a first vertical member 620, and the second rolled material installation support 602 includes a second vertical member 621. The attachment assemblies 610 are adjustably connected to the first vertical member 620 and to the second vertical member 621. The first vertical member 620 includes a strap 650, which connects to the second vertical member 621. In the embodiment shown, the first and second vertical members 620 and 621 include a plurality of holes 630 for adjusting the height of the vertical members 620 and 621 relative to the purlin 30. The attachment assemblies 610 receive the vertical members 620 and 621 in an adjustable engagement. As shown, the vertical members 620 and 621 may pass through the attachment assembly 610 at varying levels to adjust the height of the vertical members 620 and 621 relative the purlins 30.

The second vertical member 621 includes a roller 640. The strap 650 from the first vertical member 620 connects to the second vertical member 621 over its roller 640. Ratcheting tie down strap may be used as the strap 650. The ratcheting tie down straps provide the ability to tighten the strap 650 between the vertical members 620 and 621. A strap receiving point 660 on the second vertical member 621, such as hook, eye, or loop, receives an end 670 of the strap 650 from the first vertical member 620. Other cables, cords, ropes, etc. may be used to connect the rolled material installation supports 600. The strap 650 may also extend from the first vertical member 620 on one rafter to the opposite side of the bay and corresponding rafter.

Turning now to FIGS. 6 and 7, an embodiment is shown having the electric drive motor 300 to move the applicator platform 110 in a side to side manner on the trolley housing 220. The electric drive motor 300 includes a drive shaft 305 operatively engaged to a drive roller 310 for rotating the drive roller 310. The electric drive motor 300 may include a gear reduction motor. A first mounting plate 340a connects the electric drive motor 300 with an adjustable drive motor support 350 extending from the applicator platform 110. A second mounting plate 340b supports a spindle 320 via spindle support bearings 325. The first and second mounting plates 340a and 340b are attached with bolts at the base and a gripping pressure applied to the drive roller 310 is supplied by a spring 328. The spring 328 provides for the driver roller 310 to expand and still maintain a gripping pressure as the drive rollers 310 encounter joints or connections between sections of trolley housing 220.

The drive roller 310 is positioned on the outside of the trolley housing 220 and rotatably engages the trolley housing 220 to move the applicator platform 110 in a side to side manner up to the entire length of the trolley housing 220. The drive roller 310 is shown extending alongside the trolley housing 220 and engaging the spindle 320, which provides support to the drive roller 310.

The adjustable drive motor support 350 provides for vertical adjustment of the vertical position of the drive motor 300 relative to the applicator platform 110. The adjustable drive motor support 350 includes a plurality of holes 352 for connecting the adjustable drive motor support 350 to the applicator platform 110 via a pin, bolt, or other suitable engagement. In other embodiments, the drive roller 310 rotates internal to the trolley housing 220, for example, the drive roller 310 is engaged to the track 210 of the trolley housing 220. In other embodiments, the drive roller 310 and the electric drive motor 300 are both internal to the trolley housing 220.

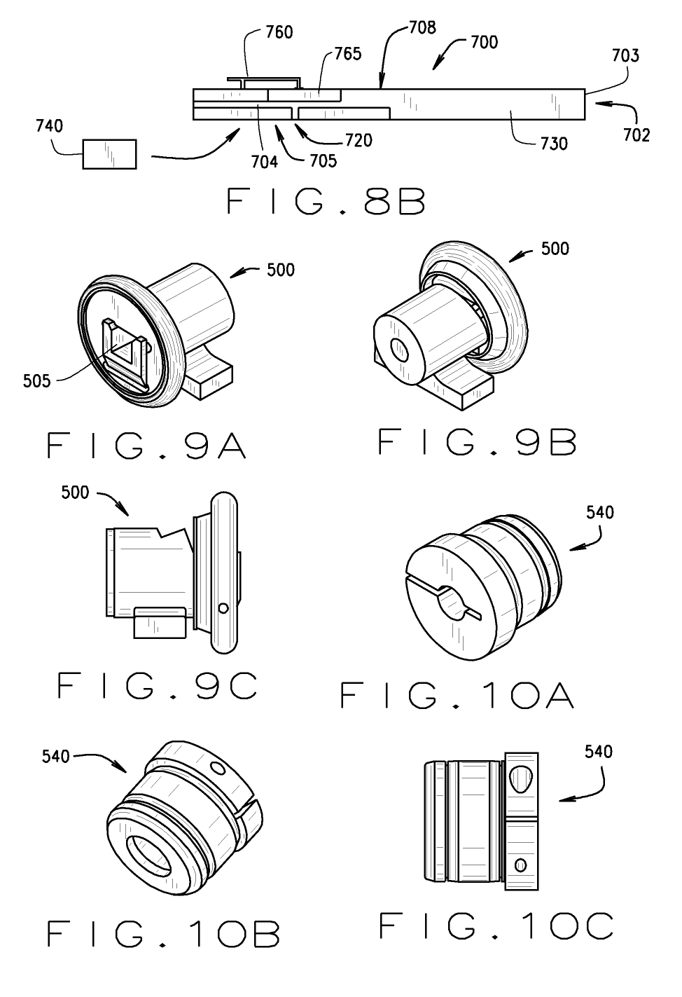

Turning now to FIGS. 8(A) and 8(B), a rolled material attachment tool 700 is shown. The rolled material attachment tool 700 is utilized to cut a straight leading edge of the material 50, clamp and hold the material 50, and then temporarily attach the material 50 to the vertical surface of the purlin 30. The tool 700 is generally made from a durable, rigid material, such a metal or metal alloy.

The tool 700 has a width to accommodate the width of the material 50. The tool 700 includes a central portion 710. The central portion 710 has a generally square or rectangular shape. The tool 700 includes an entry opening 702 in a front surface 703 of the tool. The entry opening 702 has a width to accommodate the width of the material 50.

The material 50 enters the tool at the entry opening 702 and passes into a passage 704. The tool 700 includes a slot 720 in the central portion 710 to trim an edge of the material 50 in a square manner. The slot 720 is in open communication with the entry opening 702 and the passage 704, such that the material 50 may be urged through the entry opening 702 into the passage 704 and at least to the slot 720 for trimming. Generally, the material 50 is urged past the slot 720, where the material 50 is held by integral or attached clamps 760, such as DESTACO type clamps. The clamps 760 hold the material 50 in the passage 704. The clamps 760 urge a retaining member 765 against the material 50 and a bottom surface of the passage 704.

Side portions 730 of the tool 700 guide or direct the material 50 into the tool 700 and the slot 720 in a straight manner. The slot 720 spans the width of the tool in between the side portions 730. The slot 720 is generally perpendicular to the entry opening 702. The side portions 730 are generally positioned on opposing edges of the central portion 710. The side portions 730 are generally parallel to each other and are generally perpendicular to the slot 720. Magnets 740 are attached to a bottom surface 705 of the attachment tool 700 to secure the tool 700 to the purlins 30 prior to anchoring a first support strap. Handles or hand holds 750 are attached or integral to a top surface 708 of the tool 700 to aid the worker in holding the tool 700. The tool 700 is not required to be used with the applicator 100, however, the tool 700 aids in the installation process of the material 50.

Some suitable materials for the rolled construction material will now be described. The rolled construction material 50 may be any of a variety of materials. The specific rolled construction material may depend on the purpose of the material, i.e., whether the rolled construction material is required for a safety barrier, vapor protection, aesthetic reasons, or combinations thereof, etc. A material suitable for a safety barrier should be able to support a fallen worker. Various laminates and layered materials may support a worker and be vapor impervious. A metallized low density polyester with scrim may provide sufficient yield and tenacity for a safety barrier. Other materials include single layers of polypropylene, vinyl or polyester. A two millimeter vinyl sheet having a 0.02 permeability rating and may be used as a vapor barrier.

Methods of installing the rolled construction material 50 as a safety barrier will now be described. In this particular application, the applicator 100 is elevated via a forklift or other similar method to the roof level of the building 10 and attached to the trolley housing 220. The applicator 100 may be moved transverse to adjoining rafters 40, generally in a parallel direction to the purlins 30. In this particular application, the rolled construction material 50 is applied to the underneath edge of the purlins 30. As those skilled in the art will appreciate, the applicator 100 may be mounted outside of the building 10 at or below roof level during construction or during a re-roof, and the material 50 from the rolled construction material 50 is pulled into the roof area above or below the purlins 30 inside the building 10, depending upon application demands.

Rewinding and/or unwinding of the material 50 may be assisted via manual, electric and or hydraulic means, such as a hydraulic or an electric motor, or a combination thereof. The roller motor 170 may provide all the necessary rewinding and unwinding capabilities. An electronic variable speed control may also be utilized in the roller motor 170 or in the electronics control 425. Use of such means may reduce or eliminate the need for the brake assembly 190.

The side shift of the trolley 200 will be utilized to keep most or all wrinkles out of the material 50 during its application. Electric and or hydraulic methods may be incorporated to adjust the side shift as directed from laser or optical alignment sensors in electrical communication with the electronic controls 425.

Custom width and length rolls of the material 50 are not required since a straight edge from the tool 700 and the adjustable slitter blade 186 are provided for trimming. Due to the varying width of buildings and spaces between rafters 40, the material 50 often will need to be cut to specific width. The adjustable slitter blade 186 is mounted on the applicator 100 to cut the material 50 to desired width as it is unrolled and attached to the purlins 30. An adjustable double face tape dispenser and pressure roller 187 may also be mounted on the guide roller assembly 140 for ease of application, thus ensuring a solid vapor barrier when the material 50 is overlapped. Cuts to material width, double face tape applications and trimming may also be controlled via electrical and or hydraulic methods directed from the electronic control 425 in conjunction with lasers, and/or optical controllers.

The applicator 100 and methods described herein assist in safely installing rolled construction materials. The applicator and methods assist in overcoming some of the hazards of installed rolled construction materials, such as the difficulties created by the weight of the rolled construction material, the need to replace spent rolls, and the inherent difficulty in installing the rolled construction materials to elevated positions to a partially constructed buildings.

FIG. 11 is a view of the rolled construction material 50 unrolled, dispensed, and attached to surfaces of the building 10. The plastic or metal straps 28 and the fasteners 29 hold the material 50 to the building surfaces. A sheet of the material 50 is preferably installed with an overlap region 52 with an adjacent sheet of the material 50.

Those skilled in the art will appreciate that variations from the specific embodiments disclosed above are contemplated by the invention. The invention should not be restricted to the above embodiments, but should be measured by the following claims.

What is claimed is:

1. A system for installing a rolled construction material to a building, comprising:
an applicator, the applicator comprising a shaft, a motor operatively engaged to the shaft for unwinding a roll of the rolled construction material on the shaft;
a trolley, the trolley in a moveable engagement with a trolley housing;
a support connected to the building for positioning the trolley housing adjacent the building; and
the applicator suspended under the trolley.

2. The system of claim 1, wherein the trolley housing forms a round, square, box channel, or bar track that spans an inside or outside of the building.

3. The system of claim 1, wherein the applicator is suspended from the trolley by ratcheted tie down straps or a cable placed through a pulley attached to the trolley.

4. The system of claim 1, wherein the movable engagement between the trolley and the trolley housing provides for a side to side adjustment of a lateral position of the applicator.

5. The system of claim 1, wherein the applicator comprises a safety chuck for changing rolls of the rolled construction material and a core chuck for alignment of the rolls of the rolled construction material on the shaft.

6. The system of claim 1, wherein the applicator comprises an adjustable slitter blade mounted on the applicator to cut the material to a desired width as the material is unrolled or the applicator comprises a double face tape applicator mounted on the applicator to apply tape to the material as the material is unrolled.

7. The system of claim 1, wherein the motor is a gear reduction motor comprising unwind and rewind modes, and the motor provides backpressure and prevents freewheeling as the rolled construction material is unwound from the roll.

8. The system of claim 1, wherein the applicator comprises a brake assembly, the motor comprises an electronic variable speed control, or the applicator comprises a clutch to control the winding and unwinding of the rolled construction material.

9. The system according to claim 1, wherein the motor comprises a rewind mode to pull the material tight against the building as the material is attached to the building.

10. The system according to claim 1, wherein an audible horn or a flashing light to notify the workers when the applicator is unwinding, rewinding or moving from side to side.

11. An applicator to dispense a rolled construction material to a building, comprising:
a shaft, a motor operatively engaged to the shaft for unwinding a roll of the rolled construction material on the shaft;
a spring tension guide roller assembly, the spring tension guide roller comprising one or more pinch rollers that receive the material unwound from the roll; and
an adjustable torsion brace to support the spring tension guide roller assembly, wherein the adjustable torsion brace is adjustable in a vertical manner.

12. The applicator according to claim 11, wherein the applicator is mounted on an applicator platform, and a vertical member of the torsion brace is connected to a base of the applicator platform at one of a plurality of different position.

13. The applicator according to claim 11, wherein the pinch rollers are mounted on an extending end of the vertical member of the torsion brace.

14. The applicator according to claim 11, wherein the spring tension guide roller assembly is adjustable relative to the applicator platform in order to position and dispense the material from the applicator at a height similar to the lower edge of purlins of the building.

15. A system to dispense a rolled construction material to a building, comprising:
a support connected to the building for positioning a trolley housing adjacent the building;
an electric drive motor comprising a drive shaft operatively engaged to a drive roller for rotating the drive roller along or in the trolley housing;
an applicator platform comprising an applicator to unwind a roll of the rolled construction material; and
the applicator platform mounted to the electric drive motor, wherein the electric drive motor moves the applicator platform in a side to side manner on the trolley housing.

16. The system according to claim 15, wherein an adjustable drive motor support provides for vertical adjustment of the vertical position of the electric drive motor relative to the applicator platform.

17. A method for dispensing a rolled construction material to a building, comprising:
connecting a support to the building;
connecting a trolley housing to the support, the trolley housing comprising a trolley in moveable engagement with the trolley housing;
suspending an applicator from the trolley, the applicator comprising a roll of the rolled construction material;
dispensing the rolled construction material from the applicator to the building;
moving the position of the trolley in the trolley housing; and
dispensing additional rolled construction material from the applicator to the building.

18. The method of claim 17, wherein dispensing the rolled construction material includes operating a motor to unwind or rewind the roll of rolled construction material, wherein the applicator comprises a shaft holding the roll of rolled construction material, and the motor is operatively engaged to the shaft.

19. The method of claim 17, wherein the rolled construction material is a roll of safety barrier material that is positioned on an underneath surface of purlins of the building.

20. The method of claim 17, wherein moving the position of the trolley in the travel housing includes operating a motor that drives a roller engaged to the travel housing.

21. The method of claim 17, further comprising:
suspending an applicator platform from the trolley, and the applicator platform comprises the applicator, the rolled construction material, and a spring tension guide roller assembly;
adjusting a height of the spring tension guide roller assembly relative to the applicator platform; and
dispensing the rolled construction material from the applicator to the building.

22. A rolled material attachment tool, comprising:
a central portion defining an entry opening, a passage, and a slot, wherein the entry opening is in open communication with the passage and the slot;
the slot extending across the central portion, and the slot is generally perpendicular to the entry opening;
the slot providing access to a material in the slot for trimming an edge of the material in a square manner; and
clamps integral or attached to central portion, wherein the clamps hold the material in the passage.

23. A rolled material installation support system, comprising:
a first rolled material installation support comprising a first attachment assembly to temporarily attach to a rafter, a first vertical member adjustably connected to the first attachment assembly, and a strap connected to the first vertical member, and the strap configured to connect to a second rolled material installation support or to a building structure; and
the second rolled material installation support comprising a second attachment assembly to temporarily attach to a rafter, a second vertical member adjustably connected to the second attachment assembly, and the second vertical member comprising a roller.
